(19) United States
(12) Patent Application Publication
(10) Pub. No.: US 2013/0298736 A1
(43) Pub. Date: Nov. 14, 2013

(54) ADJUSTABLE NUT WRENCH AND A METHOD OF A JAW LOCKING

(71) Applicants: Valery Shishkin, Voorhees, NJ (US); Pavel Shishkin, Kiev (UA)

(72) Inventors: Valery Shishkin, Voorhees, NJ (US); Pavel Shishkin, Kiev (UA)

(21) Appl. No.: 13/466,336

(22) Filed: May 8, 2012

(51) Int. Cl. B25B 13/18; B25B 13/12

(52) U.S. Cl. CPC B25B 13/18; B25B 13/12
USPC 81/129; 81/179

(57) ABSTRACT

An adjustable nut wrench comprising a handle section and a slide guided element that is pushed by a lever or a spring to a position where abutment surfaces are parallel to two or three of the nut's sides. A preferred embodiment of the wrench comprises two parallel abutment surfaces which are set to a maximum angle of 60 degrees to the direction of the sliding element movement. Another embodiment of the wrench has three abutment surfaces separated by an angle of 60 degrees to one another where one of them is sliding. In further embodiments of the wrench the same method, using a moving sloping abutment surface for a jaw locking, is used.

### US PATENT DOCUMENTS

| | | | |
|---|---|---|---|
| 998,462 | Jun. 27, 1911 | Curtis | 81/126 |
| 1,305,628 | Jun. 03, 1919 | Statham | 81/129 |
| 3,015,246 | Jun. 02, 1962 | Buyer | 81/167 |
| 3,173,317 | Mar. 18, 1963 | Neff | 81/167 |
| 3,956,949 | May 18, 1976 | Romano | 81/135 |
| 4,478,114 | Oct. 23, 1984 | Arena | 81/363 |
| 4,616,536 | Oct. 14, 1986 | Knebel | 81/128 |
| 4,706,528 | Nov. 17, 1987 | Inoue | 81/179 |
| 5,230,264 | Jun. 27, 1993 | Kindling | 81/129 |
| 5,528,956 | Jun. 25, 1996 | Finn | 81/356 |
| 7,096,767 | Aug. 29, 2006 | Sherburne | 81/145 |
| 7,334,507 | Feb. 26, 2008 | Piperkovski | 81/129 |

US Patent Application Pub. #2010/0083798 A1 Apr. 8, 2010, Lisle, Daniel, US Cl. 81/16.5

### BACKGROUND OF THE INVENTION

The present invention refers to an adjustable wrench used for fastening threaded nuts to threaded screws or loosening nuts from threaded screws. Sets of open-end wrenches are well known having a fixed width of jaws.

In European countries and USA widely is used a wrench with parallel sliding adjustable jaws that was first invented in 1842 year by Richard Clyburn. Improvements are following. There are many forms of adjustable wrenches/spanners. Some spanners automatically adjust to size of a nut. Simpler models use a serrated edge to lock the movable jaw like was described in U.S. Pat. No. 4,572,037. Others use a transmission gear wheel to move a sliding track with a movable jaw (U.S. Pat. Nos. 5,095,782; 6,834,569 . . . ).

One of a prior art about an adjustable wrench is U.S. Pat. No. 3,015,246. It is a nut wrench that has a V-shape hook as a moveable jaw. Two faces of the hook located by the angle of 120 degrees to each other. A fixed jaw on a handle end has an abutment surface that is parallel to one side of the hook. A standard worm nut on a shank of the hook allows adjusting the wrench's width. Such a design made the wrench more stable and convenient for an operator.

An another prior art is described in U.S. Pat. No. 4,706,528. This wrench looks like a standard Construction Spud Wrench, however, it has a sliding wedge-shaped jaw portion that is located perpendicular to a jaw motion and is engaged when an object is located between jaws. This portion moves and locks an object when the wrench is rotating in one direction and releases the object when rotation is in an opposite direction. It is ratchet-like wrench.

Pub. 2010/0083798 A1 describes an adjustable wrench structure that includes a main body, a movable body, and an adjusting wheel. The adjusting wheel is located at a rear section of the wrench, so that an operator does not have to move hands forward and backward.

An object of the present invention is to provide an improved adjustable wrench using simultaneous by force distribution on a sloping surface and a friction force to lock a jaw. That leads to multiple variants of the adjustable wrench.

Sloping surfaces was used in wrench designs as a lock, however, a sliding jaw with a sloping abutment surface was newer used as a locking devise. SUMMERY OF THE INVENTION

The object is achieved by the adjustable wrench with the features of the claims 1, ((9, 14)) 7,12. Preferred embodiments are disclosed in the depending claims.

An adjustable wrench comprising a base element and a sliding element. Said base element comprising a longitudinal handle section extending in longitudinal direction and a first abutment section protruding from the handle section. Said sliding element comprising a longitudinal slider section parallel to the handle section and being slide guided on the handle section and a second abutment section protruding from the sliding section. Said first and second abutment section each comprising abutment surfaces, and abutment surfaces being arranged face to face to each other to clamping a nut between abutment surfaces of the first and second abutment sections.

By alignment of the abutment surface of the second abutment section in an angle of maximal 60 degrees between the abutment surface and the longitudinal direction of the handle section, any additional force provided on said abutment surface of the second abutment section in conterdirection of the first abutment section which may a result in opening the wrench by sliding back of the sliding element is prevented.

In a preferred embodiment, said abutment surface of the first abutment section is aligned in an external angle of maximal 60 degrees approximately between the abutment surface and longitudinal direction of the handle section, said external angle being located outside of the abutment section, and said abutment surface of the second abutment section is aligned in an internal angle of maximal 60 degrees between the abutment surface and the longitudinal direction of the handle section, and the internal angle being located inside the abutment section.

In a further preferred embodiment, at least one of the abutment surfaces is rough in an order to hindering the nut from slipping of the wrench and ensure that a force is applied to the sliding element in a desired direction to securely hold the base element and the sliding element in a clamping position when turning the wrench. The desired direction of a force applied to the sliding element is defined by above mentioned an angle of maximal 60 degrees.

A rough surfaces can be provided, for example, by protrusions, slots, groves on at least one of the abutment surface or any other means like additional material fixed on a respective abutment surface, said additional material being rougher than the adjacent abutment surface.

In an another preferred embodiment a finger is mounted on a sliding element protruding from the sliding element in a distance to the second abutment element. By providing the finger a secure fastening connection between the base element and the sliding element of the wrench can be released in order to open the wrench.

In still an another preferred embodiment when an adjustable wrench comprising a base element and a sliding element, said base element comprising a handle section extending in a longitudinal direction and a first abutment section with two abutment surfaces located by 60 degrees to each other and protruding from the handle section; and the sliding element comprising a longitudinal sliding section and a second abutment section with an abutment surface located by 60 degrees angle approximately to both abutment surfaces of the first abutment section and protruding from the sliding section; and the abutment surface of the second abutment section is set by an angle of maximal 60 degrees approximately to a direction of the sliding element movement.

The wrench may have a lever element comprising a first lever section and a second lever section pivotally mounted on the sliding element. Preferably, the first lever section comprises a hinge for pivotally mounting the first lever section on the sliding element. Said first lever section then extends transversely to the longitudinal direction of the handle and comprises at least one snap-in element or high friction element for releasable engaging the first section with the handle section of the base element at a side opposite to the sliding element. The lever second section extends transversely to the first section in a direction away from the abutment section.

A release spring element may extend between the second lever section of the lever element and the handle section of the base element. A resilient element can be put under a hinge axel to extend a width range.

However, at least one of the abutment surfaces could have more complicated shape. An adjustable wrench comprises a base element and a sliding element, said base element comprising a handle section extending in a longitudinal direction and a first abutment section with two abutment surfaces located by 60 degrees to each other and protruding from the handle section; and the sliding element comprising a longitudinal sliding section and a second abutment section with an abutment surface located by 60 degrees angle approximately to both abutment surfaces of the first abutment section and protruding from the sliding section; and abutment surface of the second abutment section is set by an angle of maximal 90 degrees to a direction of the sliding element movement.

It is logical, it can be an opposite situation when the first abutment section is located on the sliding element, and the second abutment section is located on the handle section, and, as in the previous case, at least one of the abutment surfaces should has a high level of friction by providing slots, groves or using special materials.

This adjustable wrench has a bias spring element that is extending between the sliding element and the base element, that spring provides a bias force of the second abutment element section towards the first abutment section.

Said embodiment of the adjustable wrench has a lever element comprising a first lever section and a second lever section that is pivotally mounted on the sliding element with the first section, and first section extending transversely to a longitudinal direction of the base element and having at least one snap-in or high friction element for releasable engaging the first lever section with the handle section of the basis element at the side opposite to sliding element, and the second lever section is extending transversely to the first section in a direction away from the abutment section.

A sloping surface allows to distribute an applied force such a way that using a screw for a jaw movement becomes unnecessary. An additional presser for jaw fixation can be produced by another method.

A method fixation of a jaw, abutment surfaces of the wrench with a sliding section that is movable along a base element by a lever or by a spring at least one of the abutment surface of the wrench is set by an angle Φ degrees to the sliding section movement and forces that are produced by elements like a spring F1, a lever F2, means that create a static friction F3, equalize a force that strives to move the abutment surfaces apart or a sum of said forces is more than the separating force according to an equation:

F1+F2+F3>F sin(Φ−60),

where F is a force on an abutment surface of a fastener (a nut) when a right direction of a force is applied to the wrench.

When an abutment surface sets by the angle which is more than 60 degrees to a direction of the sliding element movement, a force striving to separate abutment surfaces has appeared. This force should be compensated. Such adjustable wrench comprising a basis element and a sliding element, and the base element comprising a longitudinal handle section with a first abutment section protruding from the handle section; and said sliding element comprising a longitudinal slider section extending parallel to the handle section and being snidely guided on the handle section, and a second abutment section protruding from the slider section; said first and second abutment sections each comprising abutment surfaces that is arranged face to face to each other or being arranged by the angle of 60 degrees to each other approximately when three surfaces is used for clamping a nut between two or three abutment surfaces when the right turning force on the wrench is present, the second abutment section is aligned at an angle Φ that is equal or more than 60 degrees between the abutment surface and a direction of the sliding section movement, and a spring, a lever and means providing a static friction produce forces F1, F2, F3 that are equalizing or more than a force F4 on a nut that tends to separate abutment surfaces according the equation:

F1+F2+F3>F4=F sin(Φ−60),

This way all dimensions of the wrench's elements can be found including a forth applying to the lever, but the angle between the abutment surface of the wrench and the direction of said surface movement is chosen in a consideration to produce of a wrench ratchet property.

In this case, as well as in cases of embodiments described above, at least one of the sliding surfaces between the base element and the sliding element has to have a high level of friction and an additional lever should be used to produce enough presser on the nut.

In an adjustable wrench design a handle can be used as a lever. This wrench comprising a base element, a sliding element, and the handle,
said base element comprising a grove for sliding element and abutment section with one or two located by the angle 60 degree to each other abutment surfaces;
said sliding element has a longitudinal section located in the base element grove and an abutment section with an abutment surface that is extending transversely to longitudinal section, and one side of the longitudinal section of the sliding element has teeth, groves or protuberances, made in a consideration of existing nuts standard,
said handle comprising a longitudinal section and a head with at least one tooth for engaging with the sliding element, and said head is pivotally mounted on the base element, the abutment surface of the sliding element sets by the angle to a direction of the sliding element movement preferably between 60 and 90 degrees. However, the sliding element can have at least two abutment surfaces or both elements can have flat abutment surfaces which are set parallel to each other.

Other version of the above described adjustable wrench will be when the sliding element has two abutment surfaces that set by the angle of 60 degrees to each other, and the abutment section of the base element located by the angle of 60 degrees approximately to each of the sliding element abutment surfaces, and the base abutment surface sets by the angle between 60 and 90 degrees to a direction of the sliding element movement.

### BRIEF DESCRIPTION OF THE DRAWING

FIG. 1 is showing forces distribution on wrench elements.

FIG. 2 is a side view of a preferred embodiment according to the present invention.

FIG. 3 is a side view of a third embodiment according to the present invention.

FIG. 4 is a perspective view of a sliding hook according to third embodiment of the present invention.

FIG. 5 is a side view of a fourth embodiment according to the present invention.

FIG. 6 is a side view of a wrench with multiple abutment surfaces.

FIG. 7 is a perspective view of a wrench with a handle as a lever.

FIG. 8 is a side view of a wrench with a separate lever.

### DETAILED DESCRIPTION OF THE DRAWING

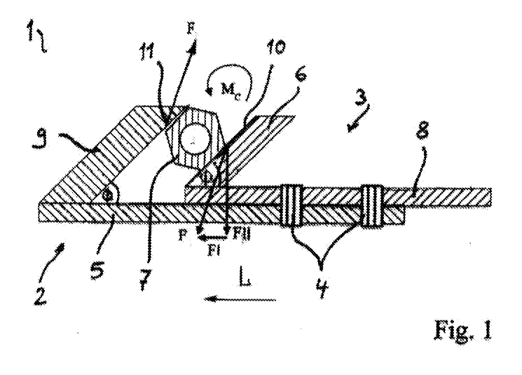

FIG. 1 shows a schematic drawing of an adjustable wrench 1 comprising a base element 2 and a sliding element 3. Said sliding element 3 is movable arranged on the base element 2 in a longitudinal direction L of the extension of both the base element 2 and the sliding element 3. Guide members 4, e.g. in form of a tunnel formed by a bent metal plate, are fixed on the base element 2 and arranged in alignment to each other such that the sliding element 3 protrudes through the tunnel to be slide guided in longitudinal direction L.

Alternative solutions for the guide members 4 are also useful, like guides having dovetail grooves and tongues and there like. These guide members 4 may be provided in any or all of the embodiments described below and in any or all of the embodiments falling in the scope and a spirit of the present invention.

Said base element 2 comprises a longitudinal handle section 5 extending longitudinal in the longitudinal direction L and further comprising a first abutment section 9 protruding from the base element said handle section 5 intended for clamping a nut 7.

The sliding element 3 comprises a longitudinal slider section 8 extending parallel to the handle section 5 and being slide guided on the handle section 5 as explained above. Said sliding element 3 further comprising a second abutment section 6 protruding from the slider section 8 being arranged to clamp a nut 7.

Both, the first and second abutment sections 6, 9, each comprises abutment surfaces 10 and 11 being arranged face to face to each other for clamping a six-cornered nut 7 between two abutment surfaces.

The abutment surface 10 of the second abutment section 6 of the sliding element 3 should be—according to the present invention—aligned in an angle Φ of maximal 60 degrees between the abutment surface 10 and the longitudinal direction of the handle section 5.

As shown in FIG. 1, the resulting force applied to the sliding element 3 when turning the wrench 1 anticlockwise for loosening or fastening the nut 7 is directed towards the fixed first abutment section 9, so that no additional force is applied to the sliding element 3 which could cause an opening of the wrench 1 by sliding back of the sliding element 3 away from the first abutment section 9.

Thus, the adjustable wrench 1 is self clamping without need of any strong snap-in or screw element otherwise being required for fixing the sliding element 3 onto the base element 2 after embracing the nut 7.

The reason of the boundary value for the angle Φ being 60° lies in the nature of the six-cornered nut 7 being divided in six angles of 60° according to the force diagram shown in FIG. 1.

A resulting force F applied to the second abutment sections 6 can be divided into a first fraction of the force F1 directed longitudinal in the direction L of the base 2 and into a second fraction of the force F11 directed perpendicular to this first fraction.

A trigonometric relation of the first fraction F1 and the force F is

F1=F sin(60°−Φ),

wherein the angle Φ is the angle between the abutment surface 10 and the longitudinal direction of the handle section 5. It should be noted that the sinus value will be negative in case of an angle Φ greater that 60°, i.e. the direction of the first fraction of force F1 would then be away from the first abutment section 9 causing the sliding element 3 to move away from this first abutment section 9 so that the adjustable wrench 1 would be opened when an additional force along the line L is not applied.

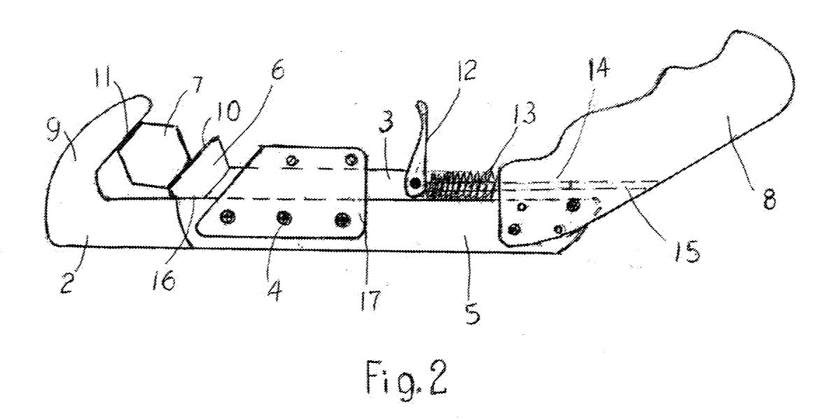

FIG. 2 shows a drawing of a second embodiment of the adjustable wrench. The longitudinal handle section 5 of the base element 2 is bent upwardly at its free end in the direction according to the adjacent first abutment section 9 of the base element 2. The advantage is that gripping and handling of the wrench is much easier.

Further, it can be seen that a finger 12 is mounted on the free end of the sliding element 3 opposite to the second abutment section 6. The finger 12 has a curved outer surface.

A spring 13 is provided between the free end of the handle section 5 and the adjacent free end of the sliding element 3. The bias spring 13 is fastened to the finger 12 to provide a bias force on the finger 12 preferably in closing direction to secure the sliding element (shank). The shank 3 is release ably fixed on the base element 2, e.g. after embracing the nut 7.

Referring to drawing FIG. 2, the wrench has the base element 2 with an abutment surface 11, a handle 8, the retractable shank 3 has an abutment surface 10 that is located approximately parallel to the base part abutment surface 11.

A spring 13, and means to move the retractable shank (that are the lever 12 and a spring pin 14 which can be welded together), wherein the retractable shank abutment surface sets by an angle maximal of 60 degrees to a line of a retractable shank motion and the spring 13 forces said fastener contact surfaces to each other.

A handle 8 has a channel 15 to except the spring pin 14. The handle can be fixed to the base section by screws.

Improving reliability at least one of the fastener contact surface can be covered with a high friction material, for example, by a diamond dust. For a smooth operation the retractable part of the wrench (shank) has at least one surface (on the top) with a law-friction that has to be polished. However, the retractable part of the wrench and the base part have at least one surface with a high level of friction 16. Avoiding polishing or creating rough surfaces can reach it. It is locking the shank by normal force during operation.

It is necessary to use two plates 17 to keep all parts together. They are fixed by screws 4 to the base section and have rivets on a top.

When providing an operation with the wrench an operator pools the shank by the lever 12 and than releases it when a fastener head (a nut) is located between abutment surfaces. Because a sloping surface creates a force that push shank forward and friction prevents shank's movement when the wrench is engaged, the fastener head is fixed between the abutment surfaces. It is clear that the design can be changed when the shank is a fixed part and the base section is retractable.

A third embodiment of the adjustable wrench has a V-shape abutment surface. Simplifying a design the base element is made movable and the element with a slopping abutment surface (the sliding element in the previous embodiment) has a handle.

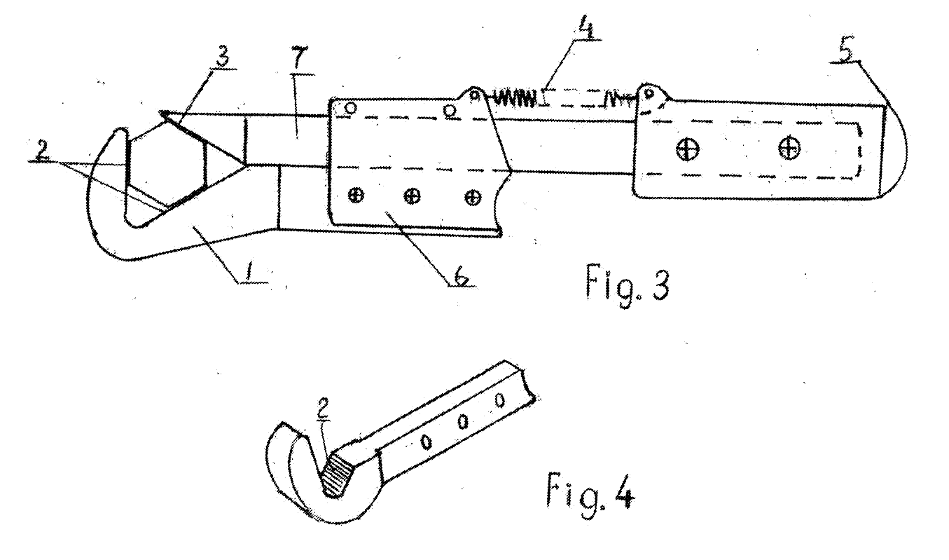

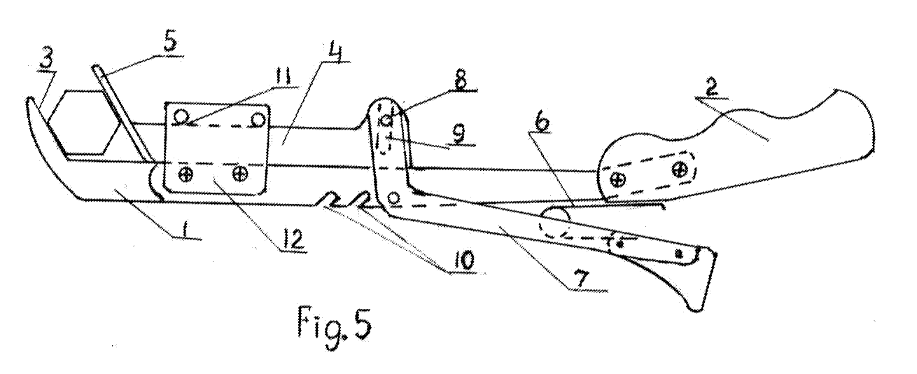

Referring to drawings FIGS. 3 and 4, the adjustable wrench comprising a base element 1 with two or several abutment surfaces 2, when at least two of them are located by the angle approximately 60 degree to each other, another part 7 with a handle 5 has a slopping abutment surface 3 which sets by the angle of 60 degrees approximately to both base element abutment surfaces, when said two elements (parts) can move relative to each other, wherein the part with the sloping abutment surface that sets by the angle of maximal approximately 60 degrees to a direction of a retractable part motion and the base element (retractable part in this design) is moving by a bias spring 4 in a close position. FIG. 4 showing sliding base element 1 with the abutment surface 2. Instead of the spring in this design a lever can be used and an angle between the abutment surface 3 and a direction of a base element 1 movement can be chosen more than 60 degrees.

In this design the base part 1 is retractable when the part with the sloping surface is fixed part and has a handle 5. It is clear that it can be vise versa design.

Two plates 6 with two rivets on a top are fixed to the base element 1 by screws.

Using this design wrench an operator has to push the base part of the wrench and put the wrench over a fastener. When a presser on the base part released the spring 4 moves the base part back and locks the fastener from three sides.

A fourth embodiment of the adjustable wrench can be used with a wider range of nuts. Referring to the drawing FIG. 5, the adjustable wrench comprising a base part 1 with a handle 2, and an abutment section with at least one abutment surface 3, a retractable shank 4 that has an abutment surface 5 that is located approximately parallel to the base part abutment surface, wherein the retractable shank abutment surface sets by an angle to a direction of a retractable shank motion and a spring 6 forces said fastener contact surfaces apart but a lever 7, when is engaged, forces them to each other. Said angle can be less than 60 degrees or more than 60 degrees depends on the lever design.

The retractable part of the wrench (the shank 4) is connected to a short part of a lever 7 by a pin 8 in a shank's slot 9. Said slot can have a resilient element. The lever has one or multiple points of an axel fixation 10. A long part of the lever has a handle.

The retractable part of the wrench has at least one surface with a high level of a friction 11. To provide a reliable fastener fixation between the abutment surfaces at least one of the abutment surfaces of the wrench has a rough surface or can be covered with a diamond dust. Two plates 12 with rivets on a top are fixed by screws to the base part. They allow frilly movement of the shank which has a rough top surface 11.

Other variant of the wrench can be made when the shank is fixed and the base part is retractable.

The wrench works as following: a spring 6 keeps the wrench open. An operator presses the lever 7 when a fastener is located between the abutment surfaces and then moves the wrench clock-wise. A lever presser and the friction provide reliable fastener fixation.

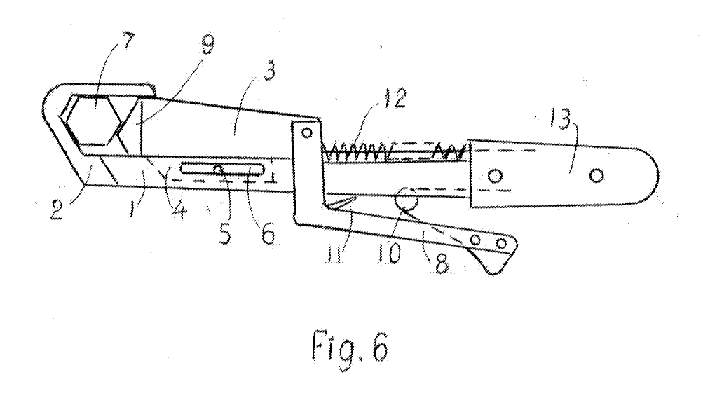

A fifth embodiment of the adjustable wrench is shown on FIG. 6. This wrench made of\ separate plates and has more complicated shape of abutment surfaces that decreases production cost and increases a width of the wrench range.

A base element 1 made of two parallel base plates and has at a free end a first abutment section 2. Said section has four abutment surfaces. Retractable shank 3 has a second abutment section 9 with two abutment surfaces and a tongue 4 located between of two base plates. Shank movement is limited by a pin 5 located in a base element slot 6.

As in the previous embodiment, the wrench has a lever 8 with a spring 10. However, for fixation the shank in a locking position a tooth 11 being used. A lower part of the base element should have a rough surface. A bias spring 12 is extending between the shank 3 and a handle 13.

Working with the wrench an operator has to pool the shank 3 back and engage the lever 8. It will keep the wrench open. The operator releases lever 8 when a fastener head is touching the first abutment section. The spring 12 moves the shank 3 forward and closes the wrench. To insure reliable contacts the lever 8 should be engaged ones more.

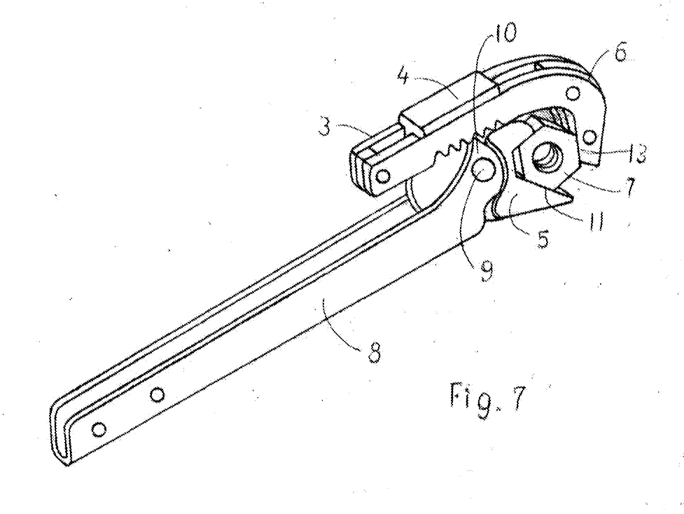

FIG. 7 shows wrench where a handle is used as a lever. In this embodiment a base element 1 is separated from a handle 8. The base element has an abutment section 5 with three abutment surfaces. Two of them, 11 and 12, set by 60 degrees angle to each other. The base element 1 comprises a guide member 4.

A sliding element 3 has an abutment section 6 with an abutment surface 13 that is se by 60-90 degrees angle to a direction of the sliding element movement. Said sliding element has protuberances or teeth and a spring inside (was not shown on the FIG. 7) that keeps the wrench closed.

A handle 8 pivotally mounted on the base element by an axel 9 and has a tooth 10.

To operate the wrench the sliding element 3 should be moved in an open position by operator's finger and released when a fastener 7 is locating between abutment surfaces 11 and 12. The handle tooth 10 should be disengaged by moving the handle up-ward.

When the spring inside the sliding element close the wrench the handle goes down and the tooth 10 creates a necessary presser to keep a fastener head (a nut) between three abutment surfaces when turning the handle anticlockwise.

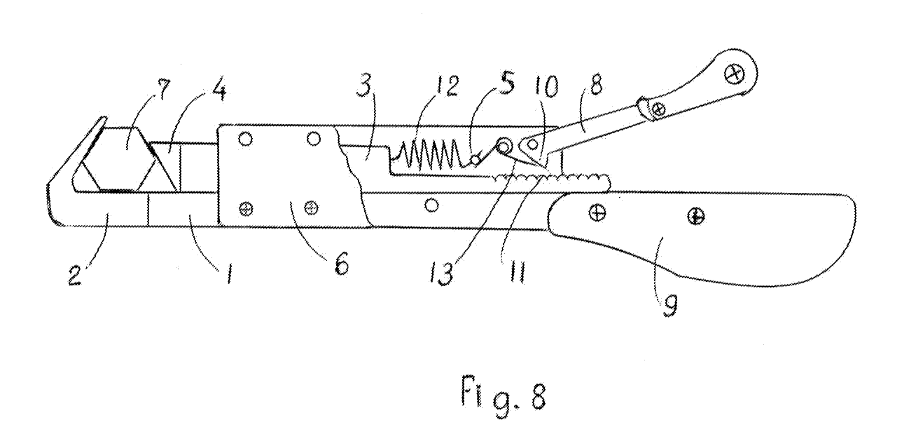

FIG. 8 shows a more complicated version of the wrench that has a separate lever. A base element 1 has made as a hook abutment section 2 and a handle 9. Sliding element 3 has an abutment section 4 and a teethed surface 11. A bias spring 12 located between the slider 3 and a pin 5 and keeps the wrench closed. A lever 8 with a tooth 10 disengaged by a spring 13. All parts are located between two plates 6 that are fastened by screws to the base element and have rivets on the top.

For clamping a nut 7 an operator has to move the slider back and engage the lever 8. When a fastener touches abutment surfaces of the element 2 the operator releases the lever and then has to press the lever once more and turn the wrench clockwise.

1. An adjustable nut wrench comprising a base element and a sliding element,
said base element comprising a handle section extending in longitudinal direction and a first abutment section protruding from the handle section;
and the sliding element comprising a longitudinal sliding section extending parallel to the longitudinal handle section and being slide guided on the handle section,
and a second abutment section protruding from the sliding section;
and the first and second abutment sections each comprising an abutment surface, and
the abutment surfaces being arranged face to face to each other for clamping a nut between the abutment surfaces of the first and second abutment sections;
said abutment surface of the second abutment section is aligned in an angle of maximal 60 degrees approximately between the abutment surface and a longitudinal direction of the handle section.

2. An adjustable nut wrench according to claim 1, wherein said abutment surface of the first abutment section is aligned in an external angle of maximal 60 degrees approximately between the abutment surface and a longitudinal direction of the handle section,
and said external angle being located outside the abutment section, and wherein said abutment surface of the second abutment section is aligned in an internal angle of maximal 60 degrees approximately between the abutment surface and the longitudinal direction of the handle section,
and said internal angle being located inside of the abutment section.

3. An adjustable nut wrench according to claim 1 or 2, wherein a bias spring element is extending between the sliding element and the base element, wherein the spring provides a bias force of the second abutment section toward the first abutment section.

4. An adjustable nut wrench according to claim 1, wherein a finger is mounted on a free end of the sliding element protruding from the sliding element in a direction of the second abutment section.

5. An adjustable nut wrench according to claim 1 or 2, wherein at least one of the abutment surfaces is rough comprising protrusions, slots, groves or a material with high friction.

6. An adjustable nut wrench according to claim 1, wherein a lever element comprising a first lever section and a second lever section that is pivotally mounted on the sliding element, said first lever section extending transversely to a longitudinal direction of the base element and having at least one snap-in element or a friction element for releasable engaging the first lever section with the handle section of the basis element at a side opposite to the sliding element, and wherein the second lever section is extending transversely to the first section in a direction away from the abutment section.

7. An adjustable nut wrench according to claim 6, wherein the first lever section that is mounted on the sliding element has an axel that is supported by a resilient element.

8. An adjustable nut wrench according to claim 6, wherein a release spring element extending between the second section of the lever element and the handle section of the base element.

9. An adjustable nut wrench comprising a base element and a sliding element,
said base element comprising a handle section extending in a longitudinal direction and a first abutment section with two abutment surfaces located by 60 degrees to each other and protruding from the handle section;
and the sliding element that is moveable by a spring or by a lever comprising a longitudinal sliding section and a second abutment section with an abutment surface located by 60 degrees angle approximately to both abutment surfaces of the first abutment section and protruding from the sliding section; wherein the abutment surface of the second abutment section is set by an angle of maximal 90 degrees approximately to a direction of the sliding element movement.

10. An adjustable nut wrench according to claim 9, wherein a bias spring element is extending between the sliding element and the base element, wherein the spring provides a bias force of the second abutment element section towards the first abutment section.

11. An adjustable nut wrench according to claim 9, wherein the lever element comprising a lever handle and a lever head with at least one tooth pivotally mounted on the base element or it's extension and the sliding element has a surface adjusted for releasable engaging with the lever element.

12. An adjustable nut wrench according to claim 9, wherein at least one of the abutment surfaces are rough comprising protrusions, slots, groves or a high friction material.

13. An adjustable nut wrench according to claim 9, wherein the first abutment section is located on the sliding element, and the second abutment section is located on the handle section.

14. A method fixation of a jaw, abutment surfaces of the wrench with a sliding section that is movable along a base element by a spring or by a lever wherein at least one of the abutment surfaces of the wrench is set by an angle Φ degrees to a direction of the sliding section motion and forces that are produced by wrench elements like a spring force F1, a lever force F2, a force that produce means that create a static friction F3, are equalized or more than a force that strives to move the abutment surfaces apart according to an equation:
F1+F2+F3>F sin(Φ−60),
where F is a force on the abutment surface of a fastener when a right direction of a force is applying to the wrench.

15. An adjustable nut wrench according to claim 1 or 14, wherein the angle Φ between a abutment surface of the wrench and a direction said surface movement is chosen in a consideration to produce a ratchet property of the wrench.

16. An adjustable nut wrench according to claim 9 or 14, comprising a base element and a sliding element, and the base element comprising a longitudinal handle section with a first abutment section protruding from the handle section;
said sliding element comprising a longitudinal slider section extending parallel to the handle section and being guided on the handle section by a lever, and a second abutment section protruding from the slider section;
said first and second abutment sections each comprising abutment surfaces arranged face to face to each other or being arranged by 60 degrees angle to each other approximately when three surfaces are used for clamping a nut between two or three abutment surfaces when a right direction of a force on the wrench is present, wherein the second abutment section is aligned at an angle Φ degrees that is equals or more than 60 degrees between the abutment surface and a direction of the sliding section movement, and a spring, a lever and means providing a static friction produce forces F1, F2, F3 that are equalized or more than a force F4 on a nut that tends to separate abutment surfaces according the equation:
F1+F2+F3>F4=F sin(Φ−60),
where F is a force on the nut abutment surface.

17. An adjustable nut wrench according to claim 1 or 9, wherein at least one of the sliding surfaces located between the base element and sliding element has a high level of friction.

18. An adjustable nut wrench according to claim 14, comprising a base element, a sliding element, and a handle, said base element comprising a grove or other guide elements for sliding element and an abutment section with one or two located by the angle of 60 degrees to each other abutment surfaces,
said sliding element has a longitudinal section located in the base element grove and an abutment section with an abutment surface that is extending transversely to longitudinal section and one side of the longitudinal section of the sliding element has teeth, groves or protuberances, and said handle comprising a longitudinal section and a head with at least one tooth for engaging with the sliding element, and said head is pivotally mounted on the base element, wherein the abutment surface of the sliding element sets by the angle to a direction of the sliding element movement, preferably between 60 and 90 degrees, and wherein distances between said teeth, groves or protuberance are chosen in accordance with a nut sizes standard.

19. An adjustable nut wrench according to claim 18, wherein the sliding element and the base element each have a flat abutment surface and those surfaces are set approximately parallel to each other.

20. An adjustable nut wrench according to claim 18, wherein the sliding element has two abutment surfaces that are set by the angle of 60 degrees to each other, and the abutment section of the base element located by the angle of 60 degrees approximately to each of the sliding element abutment surfaces, and the base abutment surface sets by the angle between 60 and 90 degrees to the direction of the sliding element movement.
